(19) United States
(12) Patent Application Publication
(10) Pub. No.: US 2021/0365810 A1
(43) Pub. Date: Nov. 25, 2021

(54) METHOD OF AUTOMATICALLY ASSIGNING A CLASSIFICATION

(71) Applicant: BayesTree Intelligence Pvt Ltd., Santa Clara, CA (US)

(72) Inventors: Partha Pratim GHOSH, Bangalore (IN); Jatin PURI, Bangalore (IN); Vijay GIRI, Bangalore (IN); Girish KOPPAR, Bangalore (IN); Avijit BISWAS, Bangalore (IN)

(73) Assignee: BayesTree Intelligence Pvt Ltd., Santa Clara, CA (US)

(21) Appl. No.: 16/946,925

(22) Filed: Jul. 11, 2020

(30) Foreign Application Priority Data
May 21, 2020 (IN) 202041020011

(51) Int. Cl. G06N 5/04; G06N 20/00; G06F 16/2453

(52) U.S. Cl. CPC G06N 5/04; G06F 16/2453; G06N 20/00

(57) ABSTRACT

A method for improving the resolution of queries tickets through the utilization of historical solution data obtained from multiple sources is provided. The method offers a methodology for automatically classifying the query, for faster retrieval of potential answers to said query, by performing a variety of similarity calculations to yield a probability of the most likely class the query is in.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### CLAIM OF PRIORITY

This application does not claim priority to any patent or patent application.

### FIELD OF THE EMBODIMENTS

The present disclosure relates generally to improvement of the functionality of a computerized automatic recommendation engine. In particular, the present disclosure and the embodiments contained therein relate to a method for improving the resolution of query tickets through the utilization of historical solution data obtained from multiple sources, by providing a methodology for automatically classifying the query, for faster retrieval of potential answers to said query.

### BACKGROUND

As machine learning and artificial intelligence systems enter ubiquity, there is a need to improve the efficiency of these systems. This is particularly true as humanity, as a whole, continues to generate more and more data which must be interpreted by these systems. Regularly, such systems are tasked with quickly reviewing millions of documents or other items of electronic information within a few moments in order to provide a desired result to an end user.

One type of machine learning system that is growing in popularity is a recommendation engine or a recommender system. These recommendation engines are used to provide an end user with a recommendation based on a review of a database of relevant information. However, given the huge amount of information such recommendation engines must review, a simple crawl of all information in the database is rarely an efficient way of retrieving recommendations. Often, such recommendation engines categorize the information contained in its database with one or more classifications. While a very helpful tool, classification of information often requires human input, which can greatly increase the operational expense of maintaining the database of the recommendation engine. This issue is compounded as the amount of information in such databases continues to increase.

Therefore, it would be beneficial if a recommendation engine could be configured to automatically classify new information added to its database, based on historical information contained in the database. Such functionality would also be helpful for organizing or reorganizing a given database to be optimized for offering a new type of recommendation. By enabling the automatic classification of data, based on the existing capabilities of the recommendation engine, it would be possible to dynamically shift the recommendation engine to provide recommendations for new tasks, with a dramatically reduced training or retraining time when compared with deep learning.

### SUMMARY

An aspect of an example embodiment in the present disclosure is to provide a method of automatically assigning a classification to a query from the similarity of an answer or potential answer to the query, where the answer or potential answer is provided by a computerized recommendation engine having a processor. In some embodiments, the method begins by providing a query in an electronic format, where the query has multiple fields that each contain a portion of text, as well as providing an electronic database. The electronic database contains a plurality of potential answers in an electronic format, where each of the plurality of potential answers is assigned to one class from a set of classes. The method then proceeds to perform a first similarity calculation on the query as well as each of the plurality of potential answers, to yield an angle of similarity between the query and each of the plurality of potential answers. A minimum angle of similarity is then defined.

From there, the recommendation engine is used to create a population by identifying all of the plurality of potential answers having an angle of similarity with the query above the defined minimum angle of similarity and placing those potential answers within the population. The method then proceeds to have the recommendation engine perform a second similarity calculation on the query and each of the plurality of potential answers within the population. A normalizer to be used in subsequent calculations is then provided. Next, the method, through use of the recommendation engine will determine the probability that each of the potential answers will fall in each of the classes of the set of classes and then will calculate a distance dissimilarity, between the query and all of the potential answers within one class, for all classes within the set of classes. Once these calculations have been performed, the method will determine the probability that the query is within each class from the set of classes by using the distance dissimilarity for each class in a likelihood function, the class probability, and the normalizing factor. The method then selects the class with the highest probability from the previous step and assigns the query to the class selected in the previous step to allow for faster processing of similar queries in the future. Preferably, the likelihood function will be modified by a damping factor in accordance with the present disclosure. In some embodiments, the likelihood function is a softmax function.

In one embodiment the first similarity calculation is similar to U.S. patent application Ser. No. 16/634,656, the contents of which are hereby incorporated by reference in their entirety. In other embodiments, the first similarity calculation is performed as follows. First, a plurality of problem inverted indices for each of the multiple fields of the query is generated and each of the multiple fields of the provided query are extended. Then, the recommendation engine will calculate a first similarity measure for each of the problem inverted indices compared against each of the plurality of potential answers. When any of the calculated first similarity measures are above a predetermined threshold, the associated potential answers are joined together. The method then proceeds to extend the multiple fields contained in the joined potential answers, and then calculates a second similarity measure for each field of the query compared with each grouped field of the joined plurality of potential answers. The top x results from the calculation of the first similarity measure and the second similarity measure, sampled from the top (x*a) results of the plurality of potential answers, where a is an integer multiple of x.

Preferably, the calculation of the second similarity measure being by first calculating a third similarity measure of each of the plurality of problem inverted indices compared with each of the plurality of potential answers within the population. Then, each of the plurality of potential answers within the population when the first similarity measure of each field is above a threshold amount are joined together and the multiple fields of the joined plurality of potential answers within the population are extended. A fourth similarity measure of each field of the query with each grouped field of the joined plurality of potential answers within the population is then calculated. From there, the top x results of the plurality of potential answers within the population based on the third similarity measure and the fourth similarity measure are provided, which are sampled from the top (x*b) results of the plurality of potential answers within the population, where b is an integer multiple of x.

In some embodiments, the normalizer is calculated by determining the marginal probability of a random potential answer within the population being within the one class of the set of classes.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE DRAWINGS

In the drawings, like elements are depicted by like reference numerals. The drawings are briefly described as follows.

FIG. 1 is a flow chart illustrating an embodiment of the method in accordance with the present disclosure.

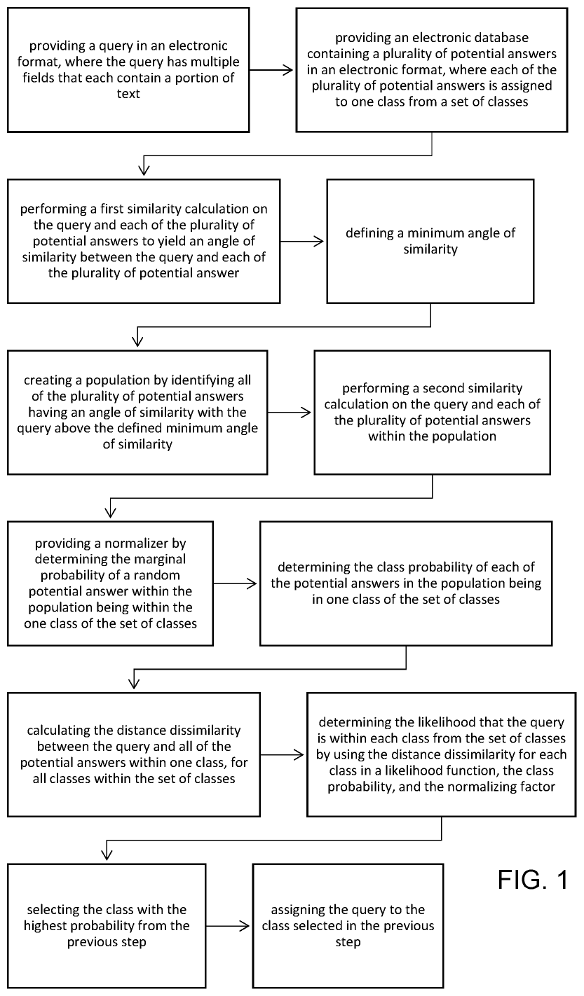

FIG. 2 is a flow chart illustrating an embodiment of the first similarity calculation in accordance with the present disclosure.

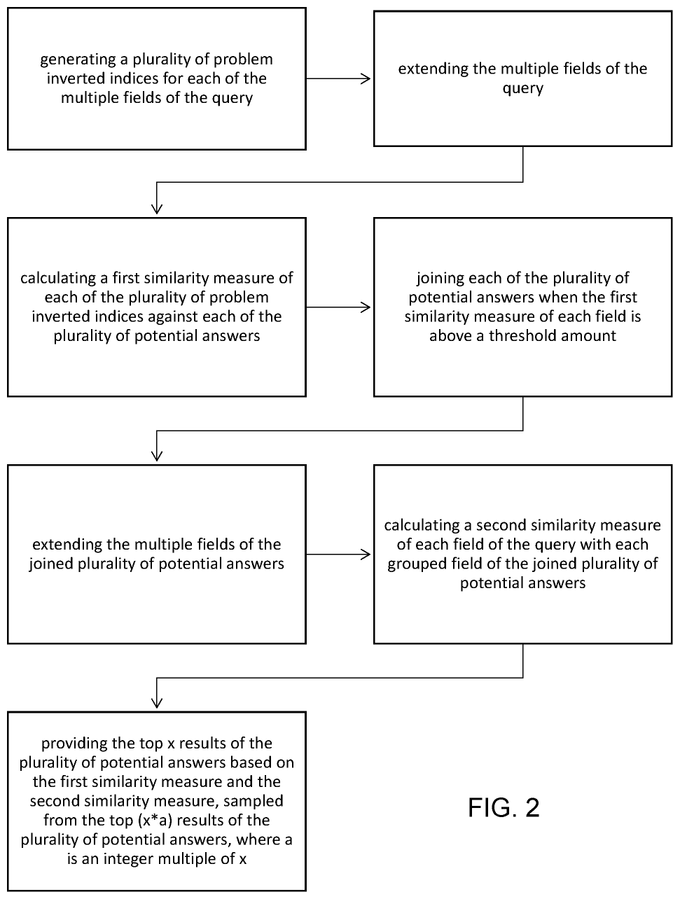

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

The present disclosure provides for a method of automatically classifying an answer or potential answer to a query provided to a recommendation engine. While the methodology contained herein may be used with a variety of artificial intelligence, machine learning, and recommendation engine system, said methodology is highly beneficial when applied to the technologies contained in U.S. patent application Ser. No. 16/634,656, the contents of which are hereby incorporated by reference in their entirety.

Generally, the method in accordance with the present disclosure takes a query (Q) and a plurality of potential answers as an input, where the plurality of potential answers each contain a label column F, where the label F contains a discrete set of classes {cᵢ: iε[1, C]}. Appling the methodology contained herein, the method in accordance with the present disclosure will take the above-mentioned input and will output a probability distribution of the query being in any given class. Put mathematically, the method in accordance with the present disclosure will determine

$$\{ P ( \frac{F = {c}_{i}}{Q} ) : i ɛ [ 1 , C ] \} ,$$

as it pertains to determining the probability distribution of a query belonging to one class of a set of classes contained in the database of a recommendation engine.

Turning to the above methodology in greater detail, the application of Bayes Theorem is instrumental in being able to turn a similarity calculation, as regularly performed by recommendation engines, into a probability distribution for determining which class a given query or potential answer is in. Taking Bayes Theorem and applying it to the above calculation, the following equality is generated:

$$P ( \frac{F = {c}_{i}}{Q} ) = \frac{P ( \frac{Q}{F = {c}_{i}} ) P ( F = {c}_{i} )}{P ( Q )} .$$

For the purposes of this disclosure,

$$P ( \frac{F = {c}_{i}}{Q} )$$

shall be referred to as a posterior probability,

$$P ( \frac{Q}{F = {c}_{i}} )$$

shall be referred to as a likelihood function, P(F=cᵢ) shall be referred to as a class probability, and P(Q) shall be referred to as a marginal probability or a normalizer. This yields the following equation:

$$Posterior Probability = \frac{Likelihood function ( Class probabilty )}{Normalizer} .$$

In order to determine the posterior probability, some additional values must be determined to complete the calculation. One such value includes a confidence score which is a similarity calculation {sim(Q, T)} between a query Q and a potential answer, also referred to as a “ticket” T, which yields an angle of similarity between the query Q and the ticket T. Another such value includes the number of tickets nᵢ within the entire database connected to the recommendation engine within a given class, expressed as {nᵢ: iε[1, C]}. Yet another such value includes a distance dissimilarity, which is expressed dⱼⁱ=1−sim(Q, Tⱼⁱ) where Tⱼⁱ:jε[1, nᵢ].

It is important to note that the similarity calculation cannot be practically determined across all tickets within the database as it would be exceedingly slow, so it is desirable to perform the similarity calculation with a specific subset of tickets within the database.

With these values defined and determined, the method in accordance with the present disclosure will now be described. To start, a computerized recommendation engine having one or more processors, one or more memories, and one or more databases is provided, where the one or more processors, the one or more memories, and the one or more databases are in electronic communication. The database contains a plurality of answers and/or potential answers to a variety of queries, where each of these answers or potential answers has multiple fields and is assigned to one class from a set of classes. In some embodiments, the answers or potential answers relate to queries for IT problems previously reported or imported into the recommendation engine.

A query having multiple fields is then provided to the recommendation engine, which performs a first similarity calculation on the query to yield an angle of similarity, or confidence score, between the query and each of the plurality of answers or potential answers. In a highly preferred embodiment, the first similarity calculation is performed by first having the processor of the recommendation engine generate a plurality of problem inverted indices for each of the multiple fields of the query, when are then extended by the processor into additional dimensions. The processor then calculates a first similarity measure for each of the problem inverted indices, against each of the plurality of answers or potential answers. The processor will then selectively join all of the answers or potential answers where the first similarity measure of each field is above a threshold amount. For the joined answers or potential answers, the processor will then extend the multiple fields contained therein. The processor will then perform a second similarity measure on each field of the query against each field of the joined plurality of answers or potential answers. Then, the top x results are then provided by the processor, comparing the first similarity measure and the second similarity measure and sampling from the top (x*a) results, where a is an integer multiple of x.

After the first similarity calculation has been performed, a minimum angle of similarity θ_{c}, is defined. A population of answers and potential answers is created by looking at the top N results, where N is the number of tickets that have a confidence score greater than the minimum angle of similarity {sim(Q, T)>θ_{c}}.

Within the population, a second similarity calculation is performed by the processor of the recommendation engine. Preferably, the second similarity calculation is performed by having the processor of the recommendation engine calculate a third similarity measure for each of the problem inverted indices, against each of the plurality of answers or potential answers within the population. The processor will then selectively join all of the answers or potential answers within the population where the third similarity measure of each field is above a second threshold amount. For the joined answers or potential answers within the population, the processor will then extend the multiple fields contained therein. The processor will then perform a fourth similarity measure on each field of the query against each field of the joined plurality of answers or potential answers within the population. Then, the top x results are then provided by the processor, comparing the third similarity measure and the fourth similarity measure and sampling from the top (x*b) results, where b is an integer multiple of x.

The class probability of a random query falling into a given class of the set of classes, based on the entire database, is performed. The marginal probability of the provided query falling into a class must be calculated, even though it will be the same for all the classes. This marginal probability will yield the normalizer, which is needed for normalization purposes. The normalizer can be expressed as

$$P ( Q ) = {\sum }_{i = 1}^{c} P ( \frac{Q}{F = {c}_{i}} ) P ( F = {c}_{i} ) .$$

From there, utilizing the distance dissimilarity, the likelihood function is calculated. In some embodiments this is a softmax function, expressed in the nomenclature of the present disclosure as

$$P ( \frac{Q}{F = {c}_{i}} ) = \frac{{\sum }_{j = 1}^{{n}_{i}} {e}^{- {d}_{j}^{i}}}{{\sum }_{i = 1}^{c} {\sum }_{s = 1}^{{n}_{i}} {e}^{- {d}_{S}^{i}}} .$$

In a highly preferred embodiment, a damping function is applied to the likelihood function to provide for better fitting of the data.

The posterior probability is calculated for each class Cᵢ contained within the population. The class with the highest posterior probability is then assigned by the processor, to the query, completing the method.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, “a first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

The invention is described above with reference to block and flow diagrams of systems, methods, apparatuses, and/or computer program products according to exemplary embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a disclosure that relates generally to improvement of the functionality of a computerized automatic recommendation engine. In particular, the present disclosure and the embodiments contained therein relate to a method for improving the resolution of query tickets through the utilization of historical solution data obtained from multiple sources, by providing a methodology for automatically classifying the query, for faster retrieval of potential answers to said query.

The disclosure is illustrated by example in the drawing figures, and throughout the written description. It should be understood that numerous variations are possible, while adhering to the inventive concept. Such variations are contemplated as being a part of the present disclosure.

What is claimed is:

1. A method of automatically assigning a classification to a query from the similarity of an answer or potential answer to the query, where the answer or potential answer is provided by a computerized recommendation engine having a processor, comprising the steps of:
providing the query in an electronic format, where the query has multiple fields that each contain a portion of text;
providing an electronic database containing a plurality of potential answers in an electronic format, where each of the plurality of potential answers is assigned to one class from a set of classes;
performing a first similarity calculation, by the processor, on the query and each of the plurality of potential answers to yield an angle of similarity between the query and each of the plurality of potential answers.
defining a minimum angle of similarity;
creating a population, by the processor, by identifying all of the plurality of potential answers having the angle of similarity with the query above the defined minimum angle of similarity;
performing a second similarity calculation, by the processor, on the query and each of the plurality of potential answers within the population;
providing a normalizer;
determining a class probability of each of the plurality of potential answers within the population being in one class of the set of classes;
calculating a distance dissimilarity, by the processor, between the query and all of the plurality of potential answers within one class, for all classes within the set of classes;
determining the likelihood, by the processor, that the query is within each class from the set of classes by using the distance dissimilarity for each class in a likelihood function, the class probability, and the normalizer;
selecting the class with the highest probability from the previous step; and
assigning the query to the class selected in the previous step.

2. The method of claim 1, the first similarity calculation comprising the steps of:
generating, by the processor, a plurality of problem inverted indices for each of the multiple fields of the query;
extending, by the processor, the multiple fields of the query;
calculating, by the processor, a first similarity measure of each of the plurality of problem inverted indices against each of the plurality of potential answers;
joining, by the processor, each of the plurality of potential answers when the first similarity measure of each of the multiple fields is above a threshold amount;
extending, by the processor, the multiple fields of the joined plurality of potential answers;
calculating, by the processor, a second similarity measure of each of the multiple fields of the query with each of the multiple fields of the joined plurality of potential answers;
providing, by the processor, a top x results of the plurality of potential answers based on the first similarity measure and the second similarity measure, sampled from a top (x*a) results of the plurality of potential answers, where a is an integer multiple of x.

3. The method of claim 2, the second similarity calculation comprising the steps of:
calculating, by the processor, a third similarity measure of each of the plurality of problem inverted indices against each of the plurality of potential answers within the population;
joining, by the processor, each of the plurality of potential answers within the population when the first similarity measure of each of the multiple fields is above a second threshold amount;
extending, by the processor, the multiple fields of the joined plurality of potential answers within the population;
calculating, by the processor, a fourth similarity measure of each of the multiple fields of the query with each joined field of the joined plurality of potential answers within the population;
providing, by the processor, the top x results of the plurality of potential answers within the population based on the third similarity measure and the fourth similarity measure, sampled from the top (x*b) results of the plurality of potential answers within the population, where b is an integer multiple of x.

4. The method of claim 3, wherein the normalizer is calculated by the processor, by determining the marginal probability of a random potential answer within the population being within the one class of the set of classes.

5. The method of claim 4, wherein the likelihood function is modified by a damping factor.

6. The method of claim 5, wherein the likelihood function is a softmax function.
